(19) United States
(12) Patent Application Publication
(10) Pub. No.: US 2016/0200009 A1
(43) Pub. Date: Jul. 14, 2016

(54) A STABILISER MOUNTING MANDREL, AND A METHOD OF FORMING A STABILISER MOUNTING MANDREL ON A DRILLING OR CASING DRILLING OR RUNNING CASING TUBULAR

(71) Applicant: TDTECH LIMITED, New Plymouth (NZ)

(72) Inventors: Kurt Ryan DOIDGE, Westown, New Plymouth (NZ); Geoffrey Neil MURRAY, Oakura (NZ)

(21) Appl. No.: 14/913,006

(22) PCT Filed: Aug. 19, 2014
(86) PCT No.: PCT/NZ2014/000169

§ 371 Date: Feb. 19, 2016

(30) Foreign Application Priority Data
Aug. 20, 2013 (NZ) 614521

(51) Int. Cl. B29C 35/02; E21B 47/00; E21B 17/10

(52) U.S. Cl. CPC B29C 35/02; E21B 17/1078; E21B 47/0006; B29K 2023/04; B29K 2075/00

(57) ABSTRACT

A mandrel for mounting a stabiliser to drilling or casing drilling or running casing tubulars. The mandrel may be formed of a base component that is one of an elastomer, semi-crystalline or amorphous polymer, a thermoset material, or a cross-linked material. The mandrel may be formed or repaired by melting a base material in a high temperature melter and delivering it to a mould placed around a drill pipe etc. A stabiliser may be formed on a sleeve by covering the sleeve with a dissolvable substance, moulding the stabiliser over the sleeve, and separating the sleeve and stabiliser so that it can freely rotate relative to the sleeve. A stabiliser for a well tubular having a cylindrical body about a well tubular having stand-off ribs extending radially outwards from the cylindrical body and a protruding ring configured to run circumferentially around and extend radially outwards from the body.

### FIELD OF THE INVENTION

The present invention relates to a mounting mandrel for mounting a stabiliser to tubulars and equipment used in the construction of wells for oil, gas, geothermal and other applications. More particularly, the present invention relates to a mounting mandrel for mounting a stabiliser for drilling and completion tubular stabilisation that can be adapted for use as both a rotating or non-rotating type, and which reduces the height and stiffness of a drill stand while also reducing friction, tubular body wear stress raisers and vibration.

### BACKGROUND OF THE INVENTION

When drilling a well bore for oil, gas, geothermal or similar, numerous problems may be encountered that largely depend on the well geometry and the type of drilling fluid used. Examples of problems that may be encountered include, but are not limited to: high torque, high drag, casing wear, drill pipe body and drill pipe tool joint wear and heat checking, vibration, rotational stick-slip related high strain rate deformation and excessive annular drilling fluid friction pressure.

Currently, rotating drill pipe rubbers are used to help solve some of these problems. However, the use of these rubbers can exacerbate other problems. For example, drill pipe rubbers tend to have somewhat limited sliding resistance and when two or more are run per joint of pipe, these may bunch up and present drilling problems. Non-rotating type drill pipe protectors are also used and are effective at reducing torque plus casing and drill pipe tool joint wear however they are prone to sliding and may create stress raisers at the metal stop collars typically used.

Non-rotating drill pipe protectors that install directly onto the drill pipe may also create stress raisers on the drill pipe due to abrasive material wearing the outside diameter of the drilling tubular as it rotates inside the protector. Additionally they have fixtures that may come loose in service and even fall off into the well bore. Furthermore, these tools may slide on the tubulars to which they are installed and jam the assembly in the well bore.

Another product that can be used is Enhanced Performance Drill Pipe Subs. This has an external appearance somewhat like a metal Archimedes screw pump and are screwed onto the drill pipe. Although this product has generally good all-round performance it is extremely expensive, plus they have the major disadvantages of increasing the height and stiffness of the drill pipe stand; thus limiting how many such tools can be used in a drill string.

To reduce mid-tube body wall reduction on drilling tubulars, either a locally applied ceramic coating or a carbon steel wear knot may be used. A problem with the ceramic coating is that it may spall in service while the metal wear knot has the disadvantage of increasing the annular fluid friction. The latter is also expensive plus the sectional shape of the wear knot is such that it creates high discontinuity stresses, thus increasing the risk of drilling tubular fatigue failure.

Various other torque and/or drag reduction type drilling tools are sub-based and therefore increase the height and stiffness of the drill pipe stand. This limits how many such tools can be used. This may compromise the ability to achieve the desired torque and/or drag reduction needed to drill or complete the well.

It is common and desirable for a drilling or operating contractor to reposition drilling tubulars within a drill string in order to distribute the fatigue conditions a particular piece of drilling tubular is exposed to. Currently this can be difficult to achieve because the identification marks may be both difficult to locate, and are almost always hard to read.

It is an object of the present invention to provide a mounting mandrel for drilling and completion tubular stabilisation equipment which goes some way to overcoming the abovementioned disadvantages or which at least provides the public or industry with a useful choice.

It is a further object of the present invention to provide a method of moulding in situ, a mounting system onto which separate drilling and completion tubular equipment can be fitted which goes some way to overcoming the abovementioned disadvantages or which at least provides the public or industry with a useful choice.

### SUMMARY OF THE INVENTION

In a first aspect, the invention may broadly be said to consist in a mandrel for mounting a stabiliser to drilling or casing drilling or running casing tubulars, the mandrel comprising a moulded cylindrical body, the material from which the mandrel is formed having a base component that is one of an elastomer, semi-crystalline or amorphous polymer, a thermoset material, or a cross-linked material.

Preferably the base component may be any one of Nitrile Rubber, Silicon Rubber, Polyurethane, Polyethylene including high and ultra-high Molecular Weight Polyethylenes, Polyamides (Nylon), Polyamide-imide, Polyphthalamide, Polyphenylene Sulfide, Polyether Ether Ketone, and/or alloys of one or more of these materials.

Preferably the base component is a polymer formed from Polyamide with substantially 15% Polyurethane or Polyethylene.

Preferably the base component further comprises between 2 and 20% PTFE powder.

Preferably the base component further comprises between 0.5 and 5% Silicone oil.

Preferably the material from which the mandrel is formed further has fibres or powders of one or more of aramid, glass, carbon fibre, nano-diamond, tourmaline, silicon dioxide, molybdenum disulfide mixed with the base component.

Preferably the fibres or powders comprise between 0% and 30% aramid, carbon, glass or mineral fibre reinforcement.

Preferably the base component further comprises between 0.5 and 5% Molybdenum Disulfide.

Preferably the material from which the mandrel is formed further has additives of the type that aid with the dissipation of static electricity mixed with the base component.

Preferably the material from which the mandrel is formed further has a coloured dye mixed with the base component to colour the mandrel.

Preferably the mandrel has an outside diameter that is similar to the outside diameter of the connections between items in the string.

Preferably the mandrel has thrust resisting lands at either end, extending radially outwards from the cylindrical body.

Preferably the thrust resisting lands taper downwards and outwards to in use merge with the outer surface of a drilling or casing drilling or running casing tubulars at each end.

Preferably the mandrel further comprises at least one radio frequency identification tag configured to provide accurate equipment identification.

Preferably the radio frequency identification tag is coded with one or more of the length, weight and grade of a pipe to which the mandrel is fixed.

Preferably the radio frequency identification tag is configured so that a user may code in data as required.

Preferably the codable data comprises one or both of: the type of polymer used, inspection data.

Preferably the mandrel further comprises one or more in situ moulded strain gauges configured to provide an accurate history of the stress accumulated in the equipment.

Preferably the strain gauge or gauges is/are configured to measure strain in at least two directions and transmit this data through the polymer.

Preferably the shape of the mandrel is such that the flow of material when moulding the mandrel is optimised.

In a second aspect the invention may broadly be said to consist in a method of forming a mounting mandrel comprising the steps of:
placing a mould around a drill pipe tool joint, drill pipe or casing;
heating the mould;
processing a moulding base material in a high temperature melter;
delivering the moulding base material to the mould.

Preferably in the step of delivering the moulding base material to the mould, the delivery is carried out via a screw and/or ram arrangement.

Preferably in the step of delivering the moulding base material to the mould, the delivery is carried out via heated barrel or insulated lines.

Preferably the method of forming a stabiliser further has an additional initial step of ensuring that the mould is adequately vented before heating the mould and delivering the moulding base material.

Preferably the method of forming a stabiliser further has an additional step during delivery of the moulding base material of applying a vacuum to a vent or vents in the mould to aid the flow and placement of the base component.

Preferably the method of forming a stabiliser further has an additional initial step of choosing the main component for the base material from one of an elastomer, semi-crystalline or amorphous polymer, a thermoset material, or a cross-linked material.

Preferably the method of forming a stabiliser further has an additional initial step of choosing the main component for the base material from any one of Nitrile Rubber, Silicon Rubber, Polyurethane, Polyethylene including high and ultra-high Molecular Weight Polyethylenes, Polyamides (Nylon), Polyamide-imide, Polyphthalamide, Polyphenylene Sulfide, Polyether Ether Ketone, and/or alloys of one or more of these materials.

Preferably in the step of choosing the main component for the base material, the chosen main component is a polymer formed from Polyamide with substantially 15% Polyurethane or Polyethylene.

Preferably in the step of choosing the main component for the base material, the chosen main component comprises between 2 and 20% PTFE powder.

Preferably in the step of choosing the main component for the base material, the chosen main component comprises between 0.5 and 5% Silicone oil.

Preferably the method of forming a stabiliser further has the additional initial step of mixing specialist fibres with the main component to form the base material before processing the base material, the fibres chosen from any one or more of aramid, glass or carbon fibre, nano-diamond, tourmaline, silicon dioxide or molybdenum disulfide.

Preferably in the step of mixing specialist fibres or powders with the main component, the fibres or powders comprise between 0% and 30% aramid, carbon, glass or mineral fibre reinforcement.

Preferably in the step of mixing specialist fibres or powders with the main component Molybdenum Disulfide comprises between 0.5 and 5% of the main component.

Preferably the method of forming a stabiliser further has an additional initial step of adding additives of the type that aid with the dissipation of static electricity to the base material before processing the base material.

Preferably the method of forming a stabiliser further has an additional initial step of adding coloured dye to the base material before processing the base material.

Preferably in the steps of processing and delivering the moulding base material the temperature of the mould and the base material are chosen such that the integrity of the internal plastic coating of the tubular will not be not affected.

Preferably the method is applied a plurality of times to form a plurality of mounting mandrels on one or more drill pipe tool joints, drill pipes, or casings the mounting mandrels spaced so as to alter the first natural frequency of the pipe or casing, or pipe or casing string.

Preferably the method comprises the initial step of placing a radio frequency identification tag on the drill pipe tool joint, drill pipe or casing so that this will be embedded within the moulding base material when delivered.

Preferably the radio frequency identification tag is chosen to be configurable to provide accurate equipment identification.

Preferably the radio frequency identification tag is coded with one or more of the length, weight and grade of the drill pipe tool joint, drill pipe or casing before being embedded.

Preferably the radio frequency identification tag is chosen as one of a type that is configurable so that a user may code in data as required.

Preferably the codable data comprises one or both of: the type of polymer used, inspection data.

Preferably the method comprises the further initial step of placing one or more strain gauges configured to provided an accurate history of the stress accumulated in the equipment on the drill pipe tool joint, drill pipe or casing so that the strain gauge will be embedded within the moulding base material when delivered.

Preferably the strain gauge or gauges is/are chosen from the type configurable to measure strain in at least two directions and transmit this data through the polymer.

Preferably the method comprises the further steps of:
at least partly covering the outer surface of the mounting mandrel with a dissolvable substance;
moulding an outer sleeve over the mounting mandrel;
separating the mounting mandrel and the outer sleeve so that the outer sleeve and mounting mandrel can freely rotate relative to one another.

Preferably the dissolvable substance is chosen from one or more of: dissolving paper, poly vinyl acetone, poly vinyl alcohol, Polycaprolactone, polypropylene, styrene, wax, wax paper, baking paper.

Preferably in the step of separating the mounting mandrel and the outer sleeve, the mounting mandrel and outer sleeve are separated by the application of heat.

Alternatively in the step of separating the mounting mandrel and the outer sleeve, the mounting mandrel and outer sleeve are separated by dissolving the dissolvable substance with water.

Alternatively in the step of separating the mounting mandrel and the outer sleeve, the mounting mandrel and outer sleeve are separated by dissolving the dissolvable substance with a solvent.

Preferably the solvent is chosen as one or more of: MEK, acetone, or petrol.

Preferably the shape of the mandrel is such that the flow of material when moulding the mandrel is optimised.

Preferably in the step of placing a mould around a drill pipe tool joint, drill pipe or casing, the mould is chosen as being one that has a protruding ring running circumferentially around and extending radially outwards from the body of the mould.

Preferably the protruding ring is rounded.

Preferably the ring is located substantially centrally.

In a third aspect, the invention may broadly be said to consist in a method of repairing or restoring a mounting mandrel comprising the steps of:
placing a mould around a drill pipe or casing around or over the top of the existing stabiliser;
heating the mould;
processing a moulding base material in a high temperature melter;
delivering the moulding base material to the mould.

Preferably in the step of delivering the moulding base material to the mould, the delivery is carried out via a screw and/or ram arrangement.

Preferably in the step of delivering the moulding base material to the mould, the delivery is carried out via heated barrel or insulated lines.

Preferably the method further has an additional initial step of ensuring that the mould is adequately vented before heating the mould and delivering the moulding base material.

Preferably the method further has an additional step during delivery of the moulding base material of applying a vacuum to a vent or vents in the mould to aid the flow and placement of the base component.

Preferably the method further has an additional initial step of choosing the main component for the base material from one of an elastomer, semi-crystalline or amorphous polymer, a thermoset material, or a cross-linked material.

Preferably the method further has an additional initial step of choosing the main component for the base material from any one of Nitrile Rubber, Silicon Rubber, Polyurethane, Polyethylene including high and ultra-high Molecular Weight Polyethylenes, Polyamides (Nylon) Polyamide-imide, Polyphthalamide, Polyphenylene Sulfide, Polyether Ether Ketone, and/or alloys of one or more of these materials.

Preferably in the step of choosing the main component for the base material, the chosen main component is a polymer formed from Polyamide with substantially 15% Polyurethane or Polyethylene.

Preferably in the step of choosing the main component for the base material, the chosen main component comprises between 2 and 20% PTFE powder.

Preferably in the step of choosing the main component for the base material, the chosen main component comprises between 0.5 and 5% Silicone oil.

Preferably the method further has an additional initial step of mixing specialist fibres with the main component to form the base material before processing the base material, the fibres chosen from any one or more of aramid, glass or carbon fibre, nano-diamond, tourmaline, silicon dioxide or molybdenum disulfide.

Preferably in the step of mixing specialist fibres or powders with the main component, the fibres or powders comprise between 0% and 30% aramid, carbon, glass or mineral fibre reinforcement.

Preferably in the step of mixing specialist fibres or powders with the main component Molybdenum Disulfide comprises between 0.5 and 5% of the main component.

Preferably the method further has an additional initial step of adding additives of the type that aid with the dissipation of static electricity to the base material before processing the base material.

Preferably the method further has an additional initial step of adding coloured dye to the base material before processing the base material.

Preferably in the steps of processing and delivering the moulding base material the temperature of the mould and the base material are chosen such that the integrity of the internal plastic coating of the tubular will not be not affected.

Preferably the method is applied a plurality of times to form a plurality of mounting mandrels on one or more drill pipe tool joints, drill pipes, or casings the mounting mandrels spaced so as to alter the first natural frequency of the pipe or casing, or pipe or casing string.

Preferably the method of repairing or restoring a mounting mandrel comprises the initial step of placing a radio frequency identification tag on the existing stabiliser so that this will be embedded within the moulding base material when delivered.

Preferably the radio frequency identification tag is chosen to be configurable to provide accurate equipment identification.

Preferably the radio frequency identification tag is coded with one or more of the length, weight and grade of the existing stabiliser before being embedded.

Preferably the radio frequency identification tag is chosen as one of a type that is configurable so that a user may code in data as required.

Preferably the codable data comprises one or both of: the type of polymer used, inspection data.

Preferably the method comprises the further initial step of placing one or more strain gauges configured to provided an accurate history of the stress accumulated in the equipment on the existing stabiliser so that the strain gauge will be embedded within the moulding base material when delivered.

Preferably the strain gauge or gauges is/are chosen from the type configurable to measure strain in at least two directions and transmit this data through the polymer.

Preferably the shape of the mandrel is such that the flow of material when moulding the mandrel is optimised.

Preferably in the step of placing a mould around a drill pipe tool joint, drill pipe or casing, the mould is chosen as being one that has a protruding ring running circumferentially around and extending radially outwards from the body of the mould.

Preferably the protruding ring is rounded.

Preferably the ring is located substantially centrally.

In a fourth aspect the invention may broadly be said to consist in a pipe, casing or tubular and integral mandrel for mounting a stabiliser, the mandrel comprising a moulded cylindrical body, the material from which the mandrel is formed having a base component that is one of an elastomer, semi-crystalline or amorphous polymer, a thermoset material, or a cross-linked material.

Preferably the base component may be any one of Nitrile Rubber, Silicon Rubber, Polyurethane, Polyethylene including high and ultra-high Molecular Weight Polyethylenes, Polyamides (Nylon), Polyamide-imide, Polyphthalamide, Polyphenylene Sulfide, Polyether Ether Ketone, and/or alloys of one or more of these materials.

Preferably the base component is a polymer formed from Polyamide with substantially 15% Polyurethane or Polyethylene.

Preferably the base component further comprises between 2 and 20% PTFE powder.

Preferably the base component further comprises between 0.5 and 5% Silicone oil.

Preferably the material from which the mandrel is formed further has fibres or powders of one or more of aramid, glass, carbon fibre, nano-diamond, tourmaline, silicon dioxide, molybdenum disulfide mixed with the base component.

Preferably the fibres or powders comprise between 0% and 30% aramid, carbon, glass or mineral fibre reinforcement.

Preferably the base component further comprises between 0.5 and 5% Molybdenum Disulfide.

Preferably the material from which the mandrel is formed further has additives of the type that aid with the dissipation of static electricity mixed with the base component.

Preferably the material from which the mandrel is formed further has a coloured dye mixed with the base component to colour the mandrel.

Preferably the mandrel has an outside diameter that is similar to the outside diameter of the connections between items in the string.

Preferably the mandrel has thrust resisting lands at either end, extending radially outwards from the cylindrical body.

Preferably the thrust resisting lands taper downwards and outwards to in use merge with the outer surface of a drilling or casing drilling or running casing tubulars at each end.

Preferably the mandrel further comprises at least one in-situ moulded radio frequency identification tag configured to provide accurate equipment identification.

Preferably the radio frequency identification tag is coded with one or more of the length, weight and grade of a pipe to which the mandrel is fixed.

Preferably the radio frequency identification tag is configured so that a user may code in data as required.

Preferably the codable data comprises one or both of: the type of polymer used, inspection data.

Preferably the mandrel further comprises one or more in situ moulded strain gauges configured to provide an accurate history of the stress accumulated in the equipment.

Preferably the strain gauge or gauges is/are configured to measure strain in at least two directions and transmit this data through the polymer.

Preferably the shape of the mandrel is such that the flow of material when moulding the mandrel is optimised.

In a fifth aspect the invention may broadly be said to consist in a method of forming an outer stabiliser on an inner sleeve comprising the steps of:
at least partly covering the outer surface of the inner sleeve with a dissolvable substance;
moulding the outer stabiliser over the inner sleeve;
separating the inner sleeve and the outer stabiliser so that the outer stabiliser and inner sleeve can freely rotate relative to one another.

Preferably the dissolvable substance is chosen from one or more of: dissolving paper, poly vinyl acetone, poly vinyl alcohol, Polycaprolactone, polypropylene, styrene, wax, wax paper, baking paper.

Preferably in the step of separating the mounting mandrel and the outer sleeve, the mounting mandrel and outer sleeve are separated by the application of heat.

Preferably in the step of separating the mounting mandrel and the outer sleeve, the mounting mandrel and outer sleeve are separated by dissolving the dissolvable substance with water.

Alternatively in the step of separating the mounting mandrel and the outer sleeve, the mounting mandrel and outer sleeve are separated by dissolving the dissolvable substance with a solvent.

Preferably the solvent is chosen as one or more of: MEK, acetone, or petrol.

Preferably the method comprises the initial step of placing a radio frequency identification tag on the inner sleeve so that this will be embedded within the moulding base material when delivered.

Preferably the radio frequency identification tag is chosen to be configurable to provide accurate equipment identification.

Preferably the radio frequency identification tag is coded with one or more of the length, weight and grade of the drill pipe tool joint, drill pipe or casing before being embedded.

Preferably the radio frequency identification tag is chosen as one of a type that is configurable so that a user may code in data as required.

Preferably the codable data comprises one or both of: the type of polymer used, inspection data.

Preferably the method comprises the further initial step of placing one or more strain gauges configured to provided an accurate history of the stress accumulated in the equipment on the drill pipe tool joint, drill pipe or casing so that the strain gauge will be embedded within the moulding base material when delivered.

Preferably the strain gauge or gauges is/are chosen from the type configurable to measure strain in at least two directions and transmit this data through the polymer.

Preferably in the step of moulding the outer stabiliser over the inner sleeve, the mould for the outer stabiliser is chosen as being one that has a protruding ring running circumferentially around and extending radially outwards from the body of the mould.

Preferably the protruding ring is rounded.

Preferably the ring is located substantially centrally.

In a sixth aspect the invention may broadly be said to consist in a stabiliser for a well tubular, comprising:
a cylindrical body configured to contact and extend around the outer surface of a well tubular;
a plurality of stand-off ribs arranged around and extending radially outwards from the cylindrical body
a protruding ring configured to run circumferentially around and extend radially outwards from the body.

Preferably the protruding ring is rounded.

Preferably the ring is located substantially centrally.

Preferably the stand-off ribs are tapered between their ends, each rib having a thick end and a thin end, the ribs alternated around the main body so that at each end of the main body the rib ends alternate between thick and thin.

Preferably the ribs are spiralled around the body.

Preferably the ends of the ribs are angled inwards or backwards, so that the ends of the stabiliser are tapered.

### BRIEF DESCRIPTION OF THE DRAWINGS

Embodiments of the present invention will now be described, by way of example only, with reference to the accompanying drawings, in which:

FIG. 1 shows a side view of a preferred embodiment of the mounting mandrel of the present invention, attached to a well tubular and used for non-rotating stabiliser applications;

FIG. 2 shows a side view of a second embodiment of the mounting mandrel of the present invention, attached to a well tubular and used for rotating stabiliser applications, the mounting mandrel having a number of shear key connectors;

FIG. 3 shows a perspective view of the mounting mandrel of FIG. 1;

FIG. 4 shows a perspective view of the mounting mandrel of FIG. 2;

FIG. 5 shows a side view of the mounting mandrel of FIG. 1 fitted with a straight bladed split-body stabiliser and mounted on a well construction tubular;

FIG. 6 shows a side view of the mounting mandrel of FIG. 1, with a stabiliser installed on and around the mounting mandrel so that the mounting mandrel can rotate within the stabiliser as the stabiliser remains non-rotational, the stabiliser having standoff blades that extend generally radially from the cylindrical body of the stabiliser, the blades slightly angled or spiraled around the main axis; and

FIG. 7 shows an embodiment of rotating drill pipe stabiliser that can be moulded in situ directly onto a well tubular.

### DETAILED DESCRIPTION OF THE INVENTION

The present invention uses specifically formulated engineering polymers to manufacture mounting mandrels. Mounting mandrels manufactured from these polymers generally exhibit low wear rates while the polymers also help to significantly reduce friction, torque and drag compared to existing mandrels. The use of engineering polymers also significantly reduces the potential for wear against adjacent surfaces while exhibiting a coefficient of restitution that assists with reducing tubular vibration. In the preferred embodiments of the present invention, the engineering polymers are applied to the pipes and tubulars using an in-situ application process. This process results in a significant reduction in localised stresses relative to the metal clamps commonly used; thereby reducing the risk of fatigue failure. The residual strain in the moulded Polymer however, provides very good axial and rotational sliding resistance.

The present invention is suitable for non-rotating stabilisers, or rotating stabilisers. Both types of stabiliser are primarily for use on drilling drill pipe, heavy weight drill pipe, drill collars, casing, tubing and associated well construction tubulars. The present invention is applicable to both new and used tubulars. The mounting mandrel, non-rotating and rotating stabilisers are described below.

### Mounting Mandrel

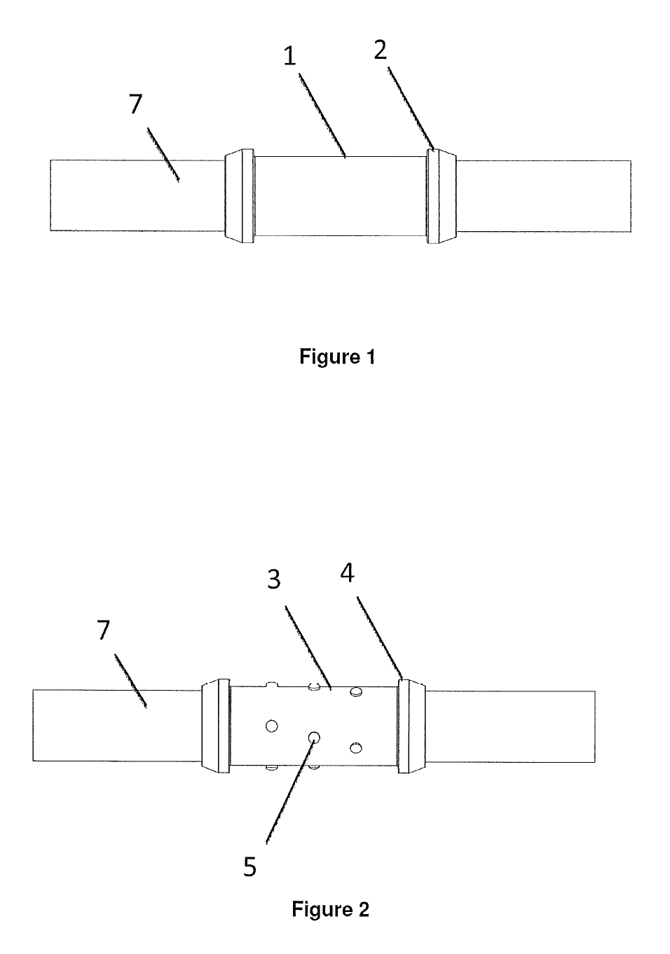

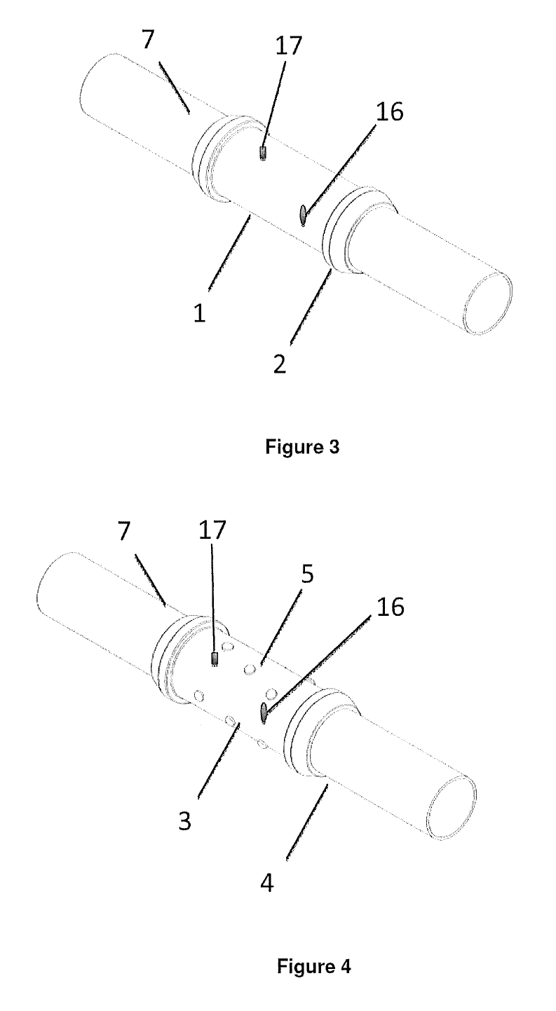

Two preferred embodiments of the mounting mandrel are shown in FIGS. 1 to 4. A first variant of mandrel 1 is shown in FIGS. 1 and 3, and a second variant of mandrel 3 is shown in FIGS. 2 and 4. The mounting mandrel 1 shown in FIGS. 1 and 2 has a generally cylindrical body that is formed by moulding concentrically around a drilling tubular 7 or similar. Circular lands 2 at either end of the mandrel 1 serve to positively locate a stabiliser in use and prevent it from moving axially relative to the mandrel 1a. In sectional elevation, the lands taper down to merge with the diameter of the tubular 7 at each end.

Another preferred embodiment of mounting mandrel 3 is shown in FIGS. 2 to 4. The non-rotating mounting mandrel 3 has a generally cylindrical body, moulded concentrically around the drilling tubular with circular lands 4 at either end of the mandrel which serve to positively locate a stabiliser and prevent it from moving axially relative to the mandrel. Shear key connectors 5 are moulded into the mandrel 3. In sectional elevation, the lands 4 taper down to merge with the diameter of the tubular 7 at each end.

The shape of the mandrels 1, 3 is such that the flow of material when moulding the mandrel is optimised. That is, the mould for the mandrels has a form that is designed to optimize the flow of the polymer as the mandrel is moulded, in order to provide good weld line integrity, including the provision, if necessary, of cold slugs along the length of the weld line.

### Split Body Stabiliser

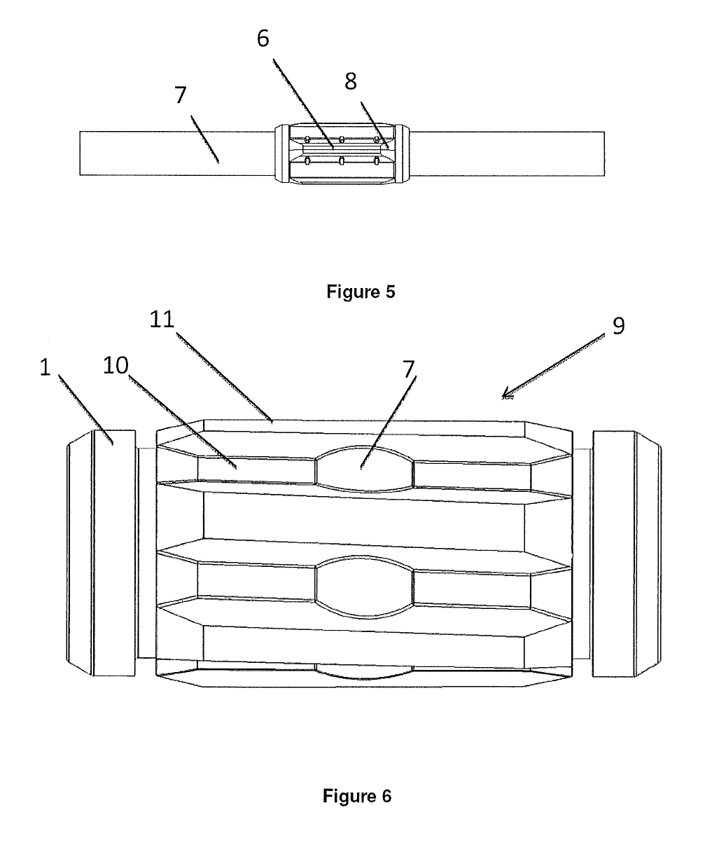

The stabiliser 6 shown in FIG. 5 is a separately manufactured split-body item which installs around the rotating or non-rotating type mounting mandrels 1, 3 described above with reference to FIGS. 1 to 4.

The stabiliser 6 features standoff blades 8 mounted to the outside of a cylindrical body. The blades may run axially parallel to the centreline of the tubular 7 as shown in FIG. 5, or they may be formed to spiral around the tubular 7 relative to the centreline. A different pitch or tightness of the spiral may be more suitable for different applications. For example, if a particular application or drilling situation requires a particular annular drilling velocity, (e.g. to enable some degree of pumping at typical drilling rotational speeds), then a stabiliser having suitably pitched blades can be created. The number of stabilisers installed per joint of pipe may also be altered to achieve the desired number of points of support wherein the more closely the pipe is supported, the higher will be the first natural frequency. Additionally, the stabilisers may be positioned at irregular intervals or spacings on the tubular in order to halt the development of various harmonics that may otherwise propagate in the drill string.

It is intended that to improve convenience and reduce pipe transportation costs, the stabilisers and wear bands will preferably be capable of being safely and efficiently installed in-situ at the drill site using self-contained equipment. This process is described below.

### In-Situ Moulded Polymer Stabilizer

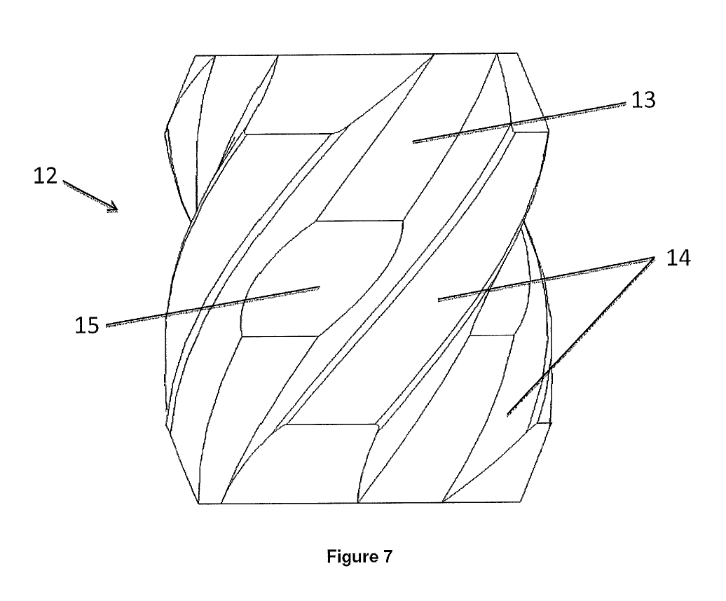

As shown in FIG. 6, stabiliser 9 forms an outer sleeve which installs around an inner sleeve such as the rotating mounting mandrel 1 described above, the mounting mandrel 1 installed on a tubular 7 or similar as described above.

The stabiliser 9 is a polymer in situ moulded item, having a main cylindrical body 10, with standoff blades 11 that extend generally radially from the cylindrical body 10. As shown in FIG. 6, the blades 11 are slightly angled or spiraled around the main axis. However, the blades may also be formed to run axially parallel to the centreline of the tubular, or they may be formed as a tighter spiral around the tubular relative to the centreline.

The outer sleeve or stabiliser 9 is formed in a similar manner, and from similar materials as, the mandrels 1, 3. The mould used is preferably of a low-pressure split type which clamps tightly to the inner sleeve or mandrel 1. In the preferred embodiment, the moulds (not shown) are split into two halves to enable installation around the mandrel 1. The moulds are heated to ensure that the material used to form the stabiliser 9 will flow properly and without risk of cold-shut. The mould and stabiliser material heating means may be electric induction, radio frequency, microwave, fluid gallery or other means. The moulding material is processed in a high temperature melter so that it is delivered to the casting mould in a highly fluid state. Delivery is via a screw and/or ram arrangement, and heated barrel or insulated lines. The mould is adequately vented and a vacuum may be pulled on the vent(s) to aid the flow and placement of the mandrel material.

The stabiliser 9 is formed so that after installation/moulding onto the inner sleeve or mandrel 1, it can be separated from the mandrel 1 so that as the pipe/tubular 7 and mandrel 1 rotate in use, the stabiliser 9 will remain non-rotational. To facilitate separation of the stabiliser 9 from the mandrel 1, during forming the inner sleeve or mandrel 1 is first covered with a dissolvable substance that is used to separate the outer sleeve or stabiliser 9 from the inner sleeve or mandrel 1. The dissolvable substance may be dissolving paper, poly vinyl acetone, poly vinyl alcohol, Polycaprolactone, polypropylene, styrene, wax, wax paper, baking paper, or any combination of these materials. The outer sleeve or stabiliser 9 is then moulded over the top of the inner sleeve or mandrel 1. Once the outer sleeve has been moulded onto the inner sleeve (as described below), the inner and outer sleeves are separated by means of heat, or dissolving with water, or some other suitable solvent or combinations thereof.

It can be seen that the first step is to mould the inner sleeve (mandrel 1) to the drill pipe. This is then wrapped with any one or combination of wax paper, wax, polyvinyl alcohol, polyvinyl acetone etc as outlined above, and the outer sleeve is then over-moulded onto the inner sleeve. The outer sleeve is then released from the inner sleeve by means of heat and/or a solvent which may be MEK, acetone, petrol or even water. In use, the drill pipe rotates with the attached inner sleeve while the outer sleeve remains stationery or non-rotating.

A different pitch or tightness of the spiral may be more suitable for different applications. For example, if a particular application or drilling situation requires a particular annular drilling velocity, (e.g. to enable some degree of pumping at typical drilling rotational speeds), then a stabiliser having suitably pitched blades can be created. The number of stabilisers installed per joint of pipe may also be altered to achieve the desired number of points of support wherein the more closely the pipe is supported, the higher will be the first natural frequency. Additionally, the stabilisers may be positioned at irregular intervals or spacings on the tubular in order to halt the development of various harmonics that may otherwise propagate in the drill string.

It is intended that to improve convenience and reduce pipe transportation costs, the stabilisers and wear bands will preferably be capable of being safely and efficiently installed in-situ at the drill site using self-contained equipment. This process is described below.

### Mould and Material

The rotating or non-rotating stabiliser bodies 6 are installed on mounting mandrels 1 or 3 which are in-situ moulded around the pipe or tubular 7. The mould used to create the mandrels 1, 3 is preferably of a low-pressure split type which clamps tightly to the drill pipe or casing 7. In the preferred embodiment, the moulds (not shown) are split into two halves to enable installation around the pipe 7. The moulds are heated to ensure that the material used to form the mandrel will flow properly and without risk of cold-shut. The mould and mandrel material heating means may be electric induction, radio frequency, microwave, fluid gallery or other means. The moulding material is processed in a high temperature melter so that the mandrel material is delivered to the casting mould in a highly fluid state. Delivery is via a screw and/or ram arrangement, and heated barrel or insulated lines. The mould is adequately vented and a vacuum may be pulled on the vent(s) to aid the flow and placement of the mandrel material.

The base material used to mould the mandrel 1 or 3 is an Elastomer or Semi-crystalline or Amorphous Polymer. The selected base material may, depending on the application, be any one of Nitrile Rubber, Silicon Rubber, Polyurethane, Polyethylene including high and ultra-high Molecular Weight Polyethylenes, Polyamides (Nylon), Polyamide-imide, Polyphthalamide, Polyphenylene Sulfide, or Polyether Ether Ketone, and/or one or more alloys of these materials. The polymer would preferably be Polyamide with up to 15% impact enhancing additives such as Polyurethane or Polyethylene, between 2 and 20% PTFE powder, between 0.5 and 5% Silicone oil, between 0.5 and 5% Molybdenum Disulfide. Many other types of thermoset, cross-linked or other products may however be used. Surprisingly and counter-intuitively, it has been found that the use of these polymers provides a mounting mandrel that can withstand the conditions necessary for both drill pipe and casing applications.

To enhance the properties of the moulding material, and particularly the heat deflection temperature, it may be reinforced with a suitable type of fibre such as Aramid, Glass or Carbon Fibre or similar. To enhance the abrasive life, reduce friction and improve the stiffness of the material, specialist materials such a nano-diamond, molybdenum disulfide, tourmaline, silicon dioxide or other powders may be added. In the preferred form, between 0 and 30% aramid, carbon, glass or mineral fibre reinforcement is added.

Furthermore, the base material may contain additives to aid with the dissipation of static electricity, thereby reducing the risk of sparks and reducing the build-up of magnetism in well or drilling tubulars.

### Moulded Rotating Stabiliser

It is possible to form a stabiliser directly onto the tubular 7, so that the stabiliser rotates with the tubular 7. A particular embodiment of in-situ moulded rotating drill pipe stabiliser 12 will now be described with reference to FIG. 7.

The stabiliser 12 has a main body 13 that has an overall generally cylindrical form, with the inner surface of the main body 13 formed onto and in contact with the outer surface of the tubular 7. A number of ribs 14 extend outwards from the main body 13, spiralled around the main body 13 from one end to the other. For any planar section taken through the stabiliser 12 perpendicular to the main axis, the body of any one of the ribs 14 extends generally radially. As well as being spiralled, the ribs 14 are tapered from one end of the main body to the other, each rib 14 having a thick and a thin end. The ribs are alternated around the main body, so that at each end of the main body, the rib ends alternate between thick and thin. The ends of the ribs are angled inwards or backwards, so that in side view as in FIG. 7, the ends of the stabiliser 12 are tapered.

The body 13 further has a raised ring or bump 15. The ring 15 has the form of a rounded protrusion that extends radially outwards from the body 13, and which runs circumferentially around the body, interrupted by the ribs 14. The ring is located substantially centrally (halfway between the ends of the stabiliser 12).

The moulding process and the materials used are the same or very similar to that described above in the section headed ‘mould and material’. The mould is clamped on to the tubular 7 in a similar fashion to the process used for creating the mandrels. Material is delivered to the casting mould in a highly fluid state, using a screw and/or ram arrangement, and heated barrel or insulated lines.

When forming the stabiliser 12, that part of the mould that forms the ring 15 aids melt flow—the melt preferentially flows around the channel that forms the centre ring or bump 15 of the moulding, in both directions, then meets on the far side from the injection point, and then flows outwardly to either end of the moulding.

### Advantages

Drilling stabilisers, either rotating or non-rotating, are used to stabilise the drilling or completion tubulars. They also serve to reduce torque, drag, rotational and axial stick/slip, and associated vibration. In the present invention, this is achieved primarily through the use of materials (as listed above) that have a low coefficient of friction. Various iterations of the device may replace tool joint hardbanding and enhance drilling tubular life.

Current rotating and non-rotating stabilisers that are known in the art may be sub mounted; in which case they make the drill string unnecessarily stiff, increase the height of stand and typically limit the number of friction reducing tools to one per stand of drill pipe. Other types of stabilisers that are known in the art may be mounted directly onto the drilling tubular. However, if directly mounted they may create stress raisers on the pipe body due to stop collar clamping forces and/or abrasive wear on the outside diameter of the tubular. Metal clamps, as currently used, also have fixtures which may come loose and even fall off in the well bore.

The in-situ moulded mounting mandrel of the present invention realizes a high residual strain in the as-moulded Polymer material due to the high moulding temperature. This strain results in very high sliding resistance between the mandrel and tubular body with empirical testing on 5″ pipe showing an axial sliding resistance of >13,000 lbf and rotational sliding resistance of >5,000 ft lbs.

The non-rotating form of the stabiliser—stabiliser 6 as shown in FIG. 5 and described above—has substantially straight ribs and is primarily aimed at providing optimal torque and drill string vibration reduction. The device also reduces casing and/or drill pipe wear, open hole key-seating and differential sticking. The devices allow closer spaced points of drilling tubular support. This stiffens the drill string thereby delaying sinusoidal buckling and enabling tubular use with the string in greater compression than would otherwise be possible.

The preferred rotating form of the stabiliser as described above has spiraled ribs, which helps to reduce annular pressure drop, thereby reducing cuttings hold-down pressure and improving the drilling rate of penetration. The device also reduces casing and/or drill pipe wear, open hole key-seating, differential sticking while lifting cuttings and thereby improving hole cleaning. The devices allow closer spaced points of drilling tubular support. This stiffens the drill string thereby delaying sinusoidal buckling and enabling tubular use with the string in greater compression than would otherwise be possible.

Following a period of service, the various wear surfaces will wear such that they are no longer effective. In the case of Semi-crystalline or Amorphous materials, the option may exist to over-mold the standoff ribs with new material although preferably the Polymer will be totally removed and replaced. For metal stabilisers, the standoff ribs may be build up with weld metal which may be a wear resistant hard facing material or the complete stabiliser body heat treated using a suitable process such as nitrocarburising or bonding. The use of both rotating and non-rotating stabilisers on drill pipe can be used to provide an optimal mix of benefits or can be used independently of each other.

The polymer used in the mounting mandrel can be coloured to enable rapid and effective identification, thereby also making it easier to rotate or switch drilling tubulars.

In all of the embodiments described above, the stabiliser may also be fitted with a radio frequency identification tag or tags to provide accurate equipment identification. The RFID tag enables the rapid and easy identification of the tubular to which it is attached (attached via the stabiliser). This assists and makes it easier to rotate or switch drilling tubulars. The RFID tag(s) is/are moulded in-situ by positioning them so that they will be embedded within the moulding base material when this is delivered, and so will end up embedded within the stabiliser. The RFID tag is configured so that it can be coded with data relating to the tubular or pipe to which it ends up attached, for example the length, weight and grade of a pipe to which the mandrel is fixed. In the preferred embodiment, the RFID tag is also configured so that a user can code in or amend additional data as required, for example the type of polymer used, inspection data, etc. An RFID tag 16 is shown in FIGS. 3 and 4, positioned on the mandrel 1 and mandrel 3 respectively, ready to be overmoulded.

The preferred embodiment of stabiliser is also fitted with strain gauges, to allow a user to track the likely fatigue buildup, and to provide an accurate history of the stress accumulated in the tubular to which the stabiliser is affixed. In the preferred embodiment, the strain gauges are configured to measure strain in at least two directions and transmit this data through the polymer to a reader. A strain gauge 17 is shown in FIGS. 3 and 4, positioned on the mandrel 1 and mandrel 3 respectively, ready to be overmoulded.

The invention as described above is effective in reducing all of the drilling problems listed in the prior art section above. It is also cost effective to use. Furthermore, should a piece of mandrel fall off, it will not compromise the well as has been the case with other rotating and non-rotating equipment.

As outlined above, operating companies tend to prefer water-based drilling mud systems as they are cheaper, and also typically less damaging to hydrocarbon bearing rock than an oil-based system. However, in practice water based mud may not deliver the lubricity needed to successfully drill the well. The invention as described above effectively extends the use of water based drilling mud systems by reducing friction.

1.-20. (canceled)

21. A method of forming a mounting mandrel comprising the steps of:
placing a mould around a drill pipe tool joint, drill pipe or casing;
heating the mould;
processing a moulding base material in a high temperature melter;
delivering the moulding base material to the mould.

22.-25. (canceled)

26. A method of forming a mounting mandrel as claimed in claim 21 further having an additional initial step of choosing the main component for the base material from one of an elastomer, semi-crystalline or amorphous polymer, a thermoset material, or a cross-linked material.

27. A method of forming a mounting mandrel as claimed in claim 21 further having an additional initial step of choosing the main component for the base material from any one of Nitrile Rubber, Silicon Rubber, Polyurethane, Polyethylene including high and ultra-high Molecular Weight Polyethylenes, Polyamides (Nylon), Polyamide-imide, Polyphthalamide, Polyphenylene Sulfide, Polyether Ether Ketone, and/or alloys of one or more of these materials.

28. A method of forming a mounting mandrel as claimed in claim 26 wherein in the step of choosing the main component for the base material, the chosen main component is a polymer formed from Polyamide with substantially 15% Polyurethane or Polyethylene.

29. A method of forming a mounting mandrel as claimed in claim 28 wherein in the step of choosing the main component for the base material, the chosen main component comprises between 2 and 20% PTFE powder.

30. A method of forming a mounting mandrel as claimed in claim 28 wherein in the step of choosing the main component for the base material, the chosen main component comprises between 0.5 and 5% Silicone oil.

31. A method of forming a mounting mandrel as claimed in claim 21 having the additional initial step of mixing specialist fibres with the main component to form the base material before processing the base material, the fibres chosen from any one or more of aramid, glass or carbon fibre, nano-diamond, tourmaline, silicon dioxide or molybdenum disulfide.

32. A method of forming a mounting mandrel as claimed in claim 31 wherein in the step of mixing specialist fibres or powders with the main component, the fibres or powders comprise between 0% and 30% aramid, carbon, glass or mineral fibre reinforcement.

33. A method of forming a mounting mandrel as claimed in claim 31 wherein in the step of mixing specialist fibres or powders with the main component Molybdenum Disulfide comprises between 0.5 and 5% of the main component.

34. A method of forming a mounting mandrel as claimed in claim 21 further having an additional initial step of adding additives of the type that aid with the dissipation of static electricity to the base material before processing the base material.

35. (canceled)

36. A method of forming a mounting mandrel as claimed in claim 21 wherein in the steps of processing and delivering the moulding base material the temperature of the mould and the base material are chosen such that the integrity of the internal plastic coating of the tubular will not be not affected.

37. A method of forming a mounting mandrel as claimed in claim 21 wherein the method is applied a plurality of times to form a plurality of mounting mandrels on one or more drill pipe tool joints, drill pipes, or casings the mounting mandrels spaced so as to alter the first natural frequency of the pipe or casing, or pipe or casing string.

38. A method of forming a mounting mandrel as claimed in claim 21 comprising the initial step of placing a radio frequency identification tag on the drill pipe tool joint, drill pipe or casing so that this will be embedded within the moulding base material when delivered.

39. A method of forming a mounting mandrel as claimed in claim 38 wherein the radio frequency identification tag is chosen to be configurable to provide accurate equipment identification.

40. A method of forming a mounting mandrel as claimed in claim 39 wherein the radio frequency identification tag is coded with one or more of the length, weight and grade of the drill pipe tool joint, drill pipe or casing before being embedded.

41. A method of forming a mounting mandrel as claimed in claim 39 wherein the radio frequency identification tag is chosen as one of a type that is configurable so that a user may code in data as required.

42. A method of forming a mounting mandrel as claimed in claim 41 wherein the codable data comprises one or both of: the type of polymer used, inspection data.

43. A method of forming a mounting mandrel as claimed in claim 21 comprising the further initial step of placing one or more strain gauges configured to provided an accurate history of the stress accumulated in the equipment on the drill pipe tool joint, drill pipe or casing so that the strain gauge will be embedded within the moulding base material when delivered.

44. A method of forming a mounting mandrel as claimed in claim 43 wherein the strain gauge or gauges is/are chosen from the type configurable to measure strain in at least two directions and transmit this data through the polymer.

45. A method of forming a mounting mandrel as claimed in claim 21 comprising the further steps of:
at least partly covering the outer surface of the mounting mandrel with a dissolvable substance;
moulding an outer sleeve over the mounting mandrel;
separating the mounting mandrel and the outer sleeve so that the outer sleeve and mounting mandrel can freely rotate relative to one another.

46. A method of forming a mounting mandrel as claimed in claim 45 wherein the dissolvable substance is chosen from one or more of: poly vinyl acetone, poly vinyl alcohol, Polycaprolactone, polypropylene, styrene, wax, wax paper.

47. A method of forming a mounting mandrel as claimed in claim 45 wherein in the step of separating the mounting mandrel and the outer sleeve, the mounting mandrel and outer sleeve are separated by the application of heat.

48. A method of forming a mounting mandrel as claimed in claim 45 wherein in the step of separating the mounting mandrel and the outer sleeve, the mounting mandrel and outer sleeve are separated by dissolving the dissolvable substance with water.

49. A method of forming a mounting mandrel as claimed in claim 45 wherein in the step of separating the mounting mandrel and the outer sleeve, the mounting mandrel and outer sleeve are separated by dissolving the dissolvable substance with a solvent.

50. A method of forming a mounting mandrel as claimed in claim 49 wherein the solvent is chosen as one or more of: MEK, acetone, or petrol.

51. A method of forming a mounting mandrel as claimed in claim 21 wherein the shape of the mandrel is such that the flow of material when moulding the mandrel is optimised.

52. A method of forming a mounting mandrel as claimed in claim 21 wherein in the step of placing a mould around a drill pipe tool joint, drill pipe or casing, the mould is chosen as being one that has a protruding ring running circumferentially around and extending radially outwards from the body of the mould.

53.-123. (canceled)
